(19) United States
(12) Patent Application Publication
(10) Pub. No.: US 2014/0283704 A1
(43) Pub. Date: Sep. 25, 2014

(54) Ink Stamp Alignment Device

(71) Applicant: Gerald Pearce, Danbury, CT (US)

(72) Inventor: Gerald Pearce, Danbury, CT (US)

(21) Appl. No.: 14/218,939

(22) Filed: Mar. 18, 2014

Related U.S. Application Data
(60) Provisional application No. 61/803,032, filed on Mar. 18, 2013.

(51) Int. Cl. B41K 3/62

(52) U.S. Cl. CPC B41K 3/62
USPC 101/481

(57) ABSTRACT

A device for the alignment of an ink stamp over a substrate comprising a single plate with a handle and an alignment aperture for securely but removeably placing the ink stamp over a substrate wherein the ink stamp can he removed and replaced in the same alignment over the substrate by holding the plate in place.

The present application claims the benefit of Provisional Application Ser. No. 61/803,032, filed on Mar. 18, 2013.

### BACKGROUND OF THE INVENTION

1. Field of the Invention

The present invention relates to an apparatus and method for aligning and holding ink stamps to create single and multiple layers of ink impressions to form a single image on a substrate.

2. Description of the Related Art.

Ink stamps, including self-inking stamps, are well known devices for making ink impressions on various materials. As convenient as they are, commonly used ink stamps are apt to leave non-uniform and variable impressions, (e.g. variations in darkness and completeness of the image) depending on many factors, such as the quality and characteristics of the stamp, level of inking and pressure exerted by the user. In this regard, it is often required to make multiple impressions in order to produce a complete, uniform image.

The design of a typical ink stamper, however, makes it difficult for the user to make repeat or layer inked impressions without the ink-stamper shifting undesirably. This is, in part, because ink stamps, over a wide variety of designs, typically have an upper portion of the stamp that slides down over a lower section with each impression. Such downward sliding portion obstructs the user's ability to grasp and hold the lower body of the stamp, creating, in effect, a “one-handed” stamping device. Moreover, due to the up and down motion required, after an initial push downward the stamp tends to pop up and shift position at least slightly, often after the downward pressure is released, causing a blurred and ineffective^{,} imprint if a second or multiple imprints arc attempted.

Moreover, a typical ink-stamper design inhibits the user's ability to review the impression without lifting the stamper entirely off the substrate. And because the stamp pad that inks the impression is retracted and hidden from user's view, once the stamper is lifted off the substrate it is extremely difficult to exactly realign the stamper to place repeat images to form a single, non-blurred impression.

A common use of ink stamps is for marking clothing or labels. Because users of ink stamps tend to only have one opportunity to activate a stamp to create a non-blurred, uniform, robust imprint, without having to reapply the image, a common solution has been to load, or over load, the stamp with extra ink. However, if the stamp pad is over-inked as a result, the imprint can be messy and may bleed through to the reverse side of a permeable substrate and, in the case of clothing, damage the garment.

Over inking is particularly a problem when marking dark clothes (navy blue, black, etc) using inking stamps that deploy a permanent white ink. White ink pigment typically does not last as long as black ink after multiple washings.

The present invention provides a means to control the extent of the imprint (i.e. darkness, or lightness of the impression), and so the user does not need to over ink the stamp or to put extra ink in the stamp cartridge. This is an important benefit when stamping some of today's more expensive high-tech materials.

Ink stamps are also commonly used for marking personalized clothing labels. Labels, such as iron-on or sew-on labels, are sometimes the best solution for marking very dark clothes, especially on materials that ink will not penetrate or on surface textures that are too rough to be stamped. Often the labels are continuous ribbons or tapes which the user stamps and then cuts for the desired application to clothing. Due to the size of the labels, however, they can be difficult substrates to work with, particularly narrow cloth or ribbon-type labels. Due to their small size, it is difficult to align the stamp pad so the stamped impression arrives in the desired location. Such labels are also difficult to hold in place during actuation of the stamp pad, which undesired motion creates blurred images. In addition, the above-described problems associated with viewing the quality of the impression, application of multiple impressions and over-inking all need to be overcome when stamping labels as well.

One prior invention provides a means to fix the position of the ink stamper above an article for the purpose of stamping multiple quantities of an article by providing an adjustable nesting bar to hold a self-inking stamp in an elevated position across a stationary and adjustable gauge bar in parallel position to one another as disclosed in U.S. Pat. No. 4,688,333. Thus, the prior invention attempts to solve a different problem and does not, as disclosed, provide a portable, compact device for aligning an ink stamp conveniently over substrates such as small, flexible cloth labels or clothing.

### SUMMARY OF THE INVENTION

The present invention provides a tool and method for aligning, re-aligning and fixedly holding the ink-stamper in place over a substrate to be stamped to allow multiple repeat and layered impressions without the ink-stamper shifting unintentionally, causing a blurred image.

The presently claimed invention provides a tool and a method to allow the review of an ink-stamped impression for a particular desired effect while allowing replacement of the ink-stamper in a properly aligned position for re-application of multiple inked impressions. The present invention enables the user to lift the stamper Out of the place-holder tool and view the quality of the imprint on the substrate. If a darker or more robust impression is desired, the user may place the stamper back into the placement-aperture to make additional, precisely-aligned imprints on top of the previous impressions resulting in a more robust, yet crisp image.

By being able to lift the stamper off the substrate to review the stamped impression while holding the alignment too in place, the user may view the depth of the imprint and stop stamping when appropriate and avoid over inking and, in the case of permeable substrates, such as clothing, prevent ink bleeding through. For marking dark substrates, particularly clothing, the present invention allows the use to perform multiple stampings on the same imprint and gel a deeper, more robust white-ink impression that will last much longer. This improvement lets the user mark both light and dark clothes using the ink-stamp with black and white ink.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a perspective view of the apparatus.

FIG. 2 is a perspective view of a second embodiment of the apparatus.

FIG. 3 is a perspective view of the invention in conjunction with a prior art ink stamp and label substrate.

FIG. 4 is a perspective view of a second embodiment of the invention in use with a ribbon substrate.

### DESCRIPTION OF THE INVENTION

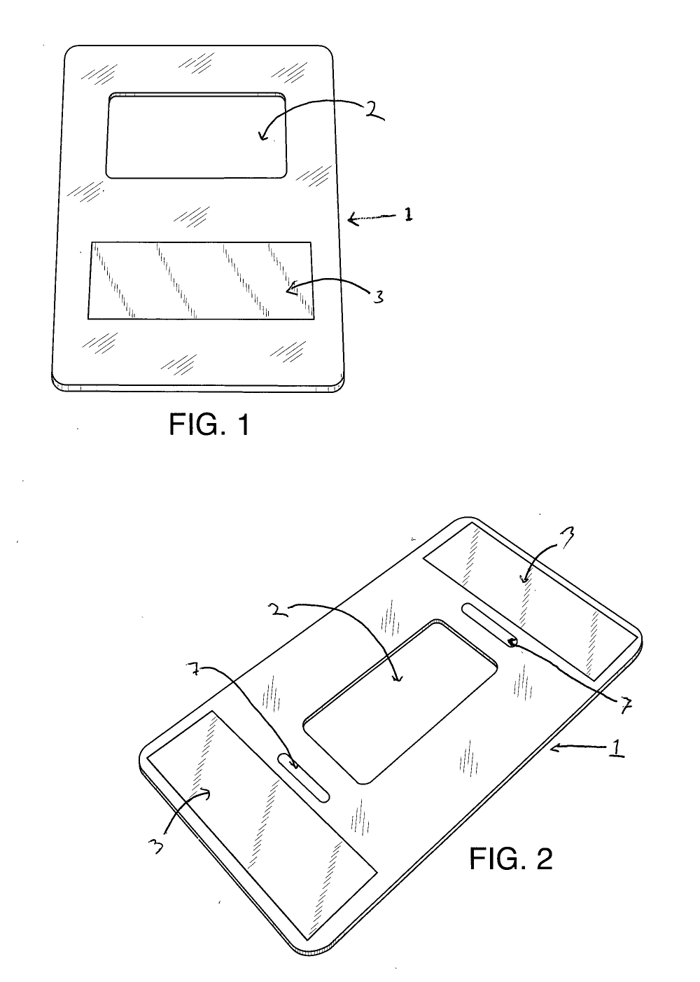

Referring to FIG. 1 an apparatus is shown for the secure alignment and re-alignment of an ink stamp preferably constructed of a transparent thermoplastic plate 1 such as Poly(methyl methacrylate. Methods of forming and cutting transparent thermoplastics are well known in the thermoplastic arts. The plate 1 of the present invention can alternatively he constructed using any type of cut glass, rigid plastic or light metal, cardboard each of which is also well known in the arts.

Plate 1 is preferably shaped and sized to allow the user to manually hold it securely in place over the substrate while providing a properly-sized aperture 2 in which to securely hold the ink stamper. There are no upper-limits as to how large the alignment plate 1 may be or restrictions as to particular dimensions other than a requirement to securely house an ink stamper of any particular size within an appropriately-sized aperture 2 and an area to sufficient for the user to grip or press the plate firmly in place. Such an area on the plate to be gripped, pressed or held onto the substrate is generally referred to as a handle area, and may be any part of the plate that is not the aperture. As shown in the Figures, a portion of the handle area may comprise grip pads 3 of any design, such as plastic, rubber or similar material adhered to the top surface of the plate 1 or etched into a smooth surface of plate 1 so that the user may securely grip plate while activating the ink stamp 5. The plate may be sized for use relative to the substrate on which the impression is to he applied. In this regard, preferred embodiments of the present invention measure from approximately 2″×4″ to approximately 6″×12″, with a more preferable sized tool measuring 2½″×4½″.

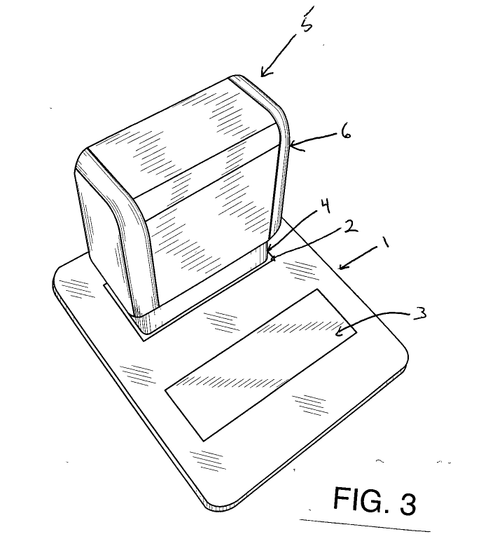

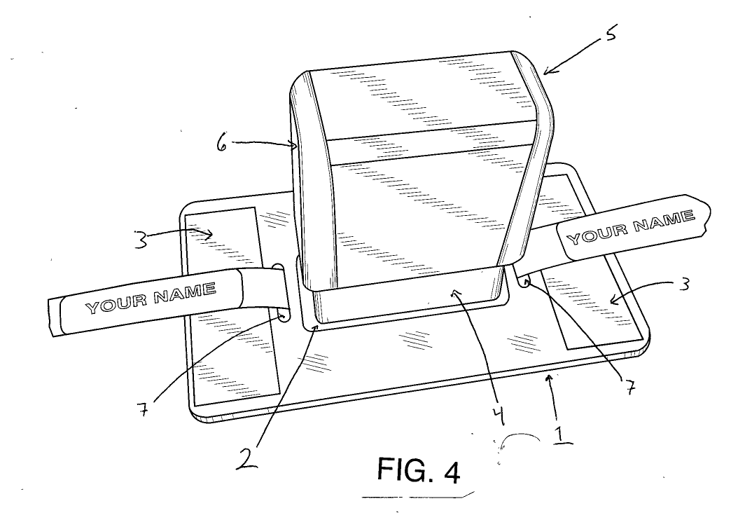

The stamp-placement aperture 2 may be centered within the tool, as shown in FIGS. 2, and 4 or may be located off center, as shown in FIGS. 1 and 3, to allow additional room for holding the tool on one side without increasing the over-all size of the tool. The stamp-alignment aperture 2 is sized to hold the lower portion 4 of ink-stamper 5 securely in place while allowing easy removal and re-insertion at the user's discretion without shifting the stamp holding tool. If the alignment-aperture 2 is too small, the stamp 5 will snap-in too securely and be difficult to place and remove in the aperture 2 without unsetting the position of the alignment tool over the substrate. If the placement-aperture 2 is too large, the stamp may shill within the alignment aperture 2, creating a blurred stamp image. Preferably, aperture 2 should be sized with the same relative dimensions as the lower housing 4 of the ink-stamper 5 which contacts the substrate, preferably from 0.0001′ to 0.001″ larger on each side.

The plate 1 tool should be at least as thick to be rigid enough for the user to align and hold the stamper in place. The maximum thickness may be increased or decreased based on ergonomic considerations. The present stamp-holder plate 1 is preferably of uniform thickness, yet other embodiments may have a slope or taper toward, or a notch or notches around, the placement aperture 2.

For use with many, but not all, ink stompers, the maximum thickness, at least around the aperture, becomes a factor as certain ink stampers have a user activated outer housing 6 that travels down approximately to the substrate along with the stamp pad (not shown) located inside stamp 5; if the travel of outer housing 6 is impeded too far from the substrate, the stamp pad will not reach the substrate. The thickness of the stamp-alignment tool around the aperture 2 is, at a minimum, just thick enough to hold the ink-stamper securely in place but still allow easy removal and reinsertion of the stamper. For use with ink-stampers with the aforementioned outer housing 6, the thickness of the stamp holding tool proximal to the perimeter of the aperture 2 can range from approximately 0.04″ to approximately 0.1″ thick, with a preferred thickness of 0.06″.

To effect placement of the stamp impression on a substrate using the stamp alignment and holding tool, the user places the plate 1 over the substrate with the alignment-aperture 2 aligned properly over the substrate such that the stamp will impact the substrate in the proper alignment and position for the desired image. The user then places a lower portion 4 of the stamp 5 within the aperture 2 of the stamp-holding tool such that it is held firmly in place. The user then holds the plate 1, in place manually or by other means, preferably by applying downward pressure on the plate on top of the substrate on a flat surface, and activates the stamp 5, optionally using the user's other hand, to make an imprint on the substrate. The stamp 5 may be removed from the aperture 2, while the plate is held in place over the substrate, the impression viewed and evaluated, and if desired, the stamp may be placed back in the aperture 2 and the stamp impression reapplied with the foregoing steps repeated as often as necessary or desired by the user.

FIGS. 2 and 4 show one embodiment of the present invention where the plate 1 has an addition feature of slot-like apertures 7 lateral to the alignment aperture 2 to allow a flexible label substrates to be threaded through and under plate 1 and directly beneath the alignment aperture 2, thereby holding the label ribbon securely in place and aligned properly for stamping. The slot apertures 7 may be placed anywhere on the plate laterally to aperture 2, with slots 7 that are more proximal to aperture b providing less friction and requiring less force for the substrate to be passed through. The slots 7 may be any size to fit ribbon substrates of different sizes, but in n one preferred embodiment for use on clothing labels, the label slots 7 measure ⅝″×⅛″ and are each located approximately ¼″ lateral to the aperture 2 along the horizontal stamping axis. Additional label-slots or clips may be added if desired to increase the resistance and tension on the substrate label.

The threaded substrate is thus held taught and securely in place beneath aperture 2 during the stamping or multiple stamping process to avoid movement of the substrate and consequential blurring of the image. In this embodiment, in the same manner as described previously, the stamp may be removed from the aperture to allow the impression on the label substrate to be evaluated and if necessary, reapplication of the stamp impressions. A continuous feed of substrate ribbon can be pulled through the label-slots 7, across and underneath the alignment aperture 7. When the desired impression is achieved, the user may pull the ribbon substrate, advancing blank substrate underneath the aperture 2 for additional stamp impressions thus allowing, the user to create a continuous ribbon of labels that may be individually prepared for affixing to another desired substrate, such as clothing.

The method for using the stamp-holding tool comprises the steps of:
1. Placing the plate 1 over a substrate, with the alignment-aperture aligned properly over the substrate such that the stamp pad will impact the substrate in the proper alignment and position for the desired image;
2. Securely but removeably placing a lower portion of the stamp 4 within the alignment aperture 2;
3. Activating the stamp;
4. Removing the stamp from the alignment-aperture h e maintaining the position of the plate 1 over the substrate;
5. Reviewing the quality of the stamped image;
6. Optionally repeating steps 2 through 5 above.

The method for using the stamp-holding tool on a flexible ribbon-type label substrate comprises the steps of:
1. feeding a blank flexible label substrate downward into one label-slot opening;
2. pulling the substrate forward such that it passes under the bottom surface of the stamp-holder and underneath the placement aperture;
3. threading the substrate hack up through an opposing label-slot;
4. optionally threading the substrate through one or more additional clamping label-slots;
5. Placing a lower portion of a stamp within the placement-aperture of the stamp-holding tool;
6. Activating the stamp;
7. Removing the stamp from the placement-aperture while fixedly maintaining the position of the tool over the substrate;
8. Reviewing the quality of the stamped image;
9. Optionally repeating steps 5 through 8 above.
10. Optionally advancing the label substrate forward to expose an unused quantity of substrate beneath the placement-aperture;
11. Optionally repeating steps 5 though 10 above;
12. Removing the label substrate from the stamp-holding tool.

This disclosure merely describes several embodiments and preferred embodiments of the present invention and how to make and use the same. Nothing is this disclosure is intended to or should be construed to limit the scope of the invention.

I claim:

1. A device for the alignment of an ink stamp over a substrate comprising a single plate with an alignment aperture for securely but removeably housing said ink stamp over a substrate to be stamped and wherein said plate further comprises a handle.

2. The device of claim 1 wherein said plate is transparent.

3. The device of claim 1 further comprising two label apertures each disposed on either side of said alignment aperture.
